(19) United States
(12) Patent Application Publication
(10) Pub. No.: US 2011/0018905 A1
(43) Pub. Date: Jan. 27, 2011

(54) PRINTED CIRCUIT BOARD LAYOUT SYSTEM AND METHOD FOR ADJUSTING CHARACTER ORIENTATION THEREOF

(75) Inventor: XIAO-CHENG SHENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen)., CO., LTD., Shenzhen City (CN); HON HAI PRECISION INDUSTRY CO., LTD., Tu-Cheng (TW)

(21) Appl. No.: 12/791,870

(22) Filed: Jun. 2, 2010

(30) Foreign Application Priority Data
Jul. 27, 2009 (CN) 200910304880.0

(51) Int. Cl. G09G 5/30

(52) U.S. Cl. 345/689; 345/168

(57) ABSTRACT

A printed circuit board layout system includes a layout module, an acquiring module, and an adjusting module. The layout module creates a PCB layout diagram file based on a circuit schematic diagram. The PCB layout diagram file includes characters and orientation angles associated with the characters. The acquiring module acquires the characters and the orientation angles of the corresponding characters in response to a user input. The adjusting module adjusts the orientation angles of the characters to a predetermined angle.

### BACKGROUND

1. Technical Field

The present disclosure relates to printed circuit board layout systems, particularly, to a printed circuit board layout system capable of adjusting character orientation.

2. Description of Related Art

A printed circuit board (PCB) layout diagram file is created based on a circuit schematic diagram, and includes characters indicating where to mount components on the PCB. However, as shown in FIG. 6, when the characters are printed in different orientations, it is inconvenient for the users to quickly view the characters and know where to mount the corresponding components.

Therefore, what is needed is a PCB layout system to overcome the described shortcoming.

### BRIEF DESCRIPTION OF THE DRAWINGS

FIG. 1 is a block diagram of a hardware infrastructure of a printed circuit board layout system in accordance with an exemplary embodiment.

FIG. 2 is a schematic diagram showing a working window including a plurality of characters displayed on the printed circuit board layout system of FIG. 1.

FIG. 3 is similar to FIG. 2, but showing a working window including a plurality of characters whose orientation angles have been adjusted.

FIG. 4 is a block diagram of a hardware infrastructure of a printed circuit board layout system in accordance with another embodiment.

FIG. 5 is a flowchart of a method for adjusting the orientation angles of the characters implemented by the printed circuit board layout system of FIG. 1, in accordance with an exemplary embodiment.

FIG. 6 is a schematic diagram of a PCB layout diagram file created by a printed circuit board layout system in a related art.

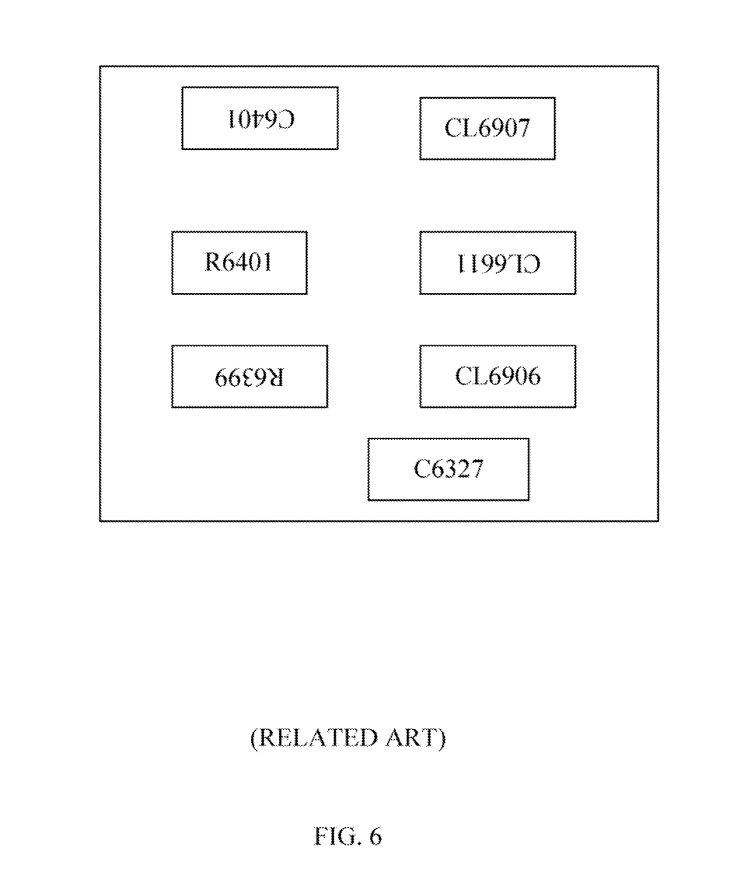

### DETAILED DESCRIPTION

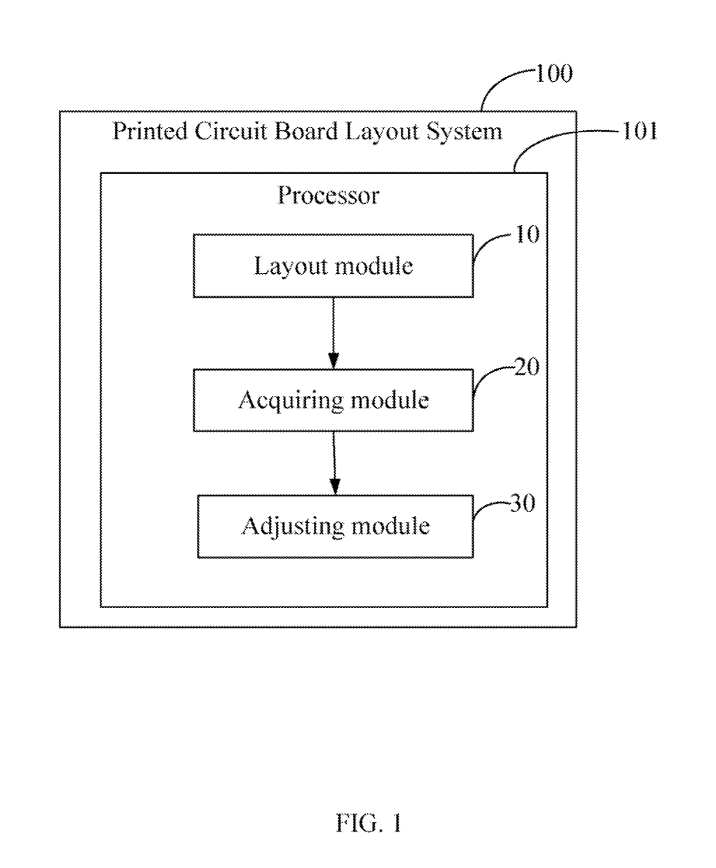

Referring to FIG. 1, a printed circuit board (PCB) layout system 100 is provided. The system 100 includes a processor 101 to execute a plurality of function modules. The function modules include a layout module 10, an acquiring module 20, and an adjusting module 30.

The layout module 10 is configured for creating a PCB layout diagram file based on a circuit schematic diagram. The PCB layout diagram file includes a plurality of characters and orientation angles associated with the characters. The characters are displayed adjacent to the corresponding components, such as resistors, capacitors, indicating the positions where the components are mounted. The orientation angles are parameters to control the display orientations of the characters.

The acquiring module 20 is configured for acquiring the characters and the associated orientation angles from the PCB layout diagram file, and sending them to the adjusting module 30 in response to a user input. In the embodiment, the acquiring module 20 can first search for the characters in the PCB layout diagram file, and acquire the orientation angles associated with the acquired characters.

The adjusting module 30 is configured for adjusting the orientation angles of the characters to a predetermined angle. In the embodiment, when adjusting the character orientation, the adjusting module 30 first compares the acquired orientation angles with the predetermined angle. If the former is different from the latter, the adjusting module 30 adjusts the acquired orientation angles to the predetermined angle. The predetermined angle of the character may be 0 degrees, 45 degrees, 90 degrees, etc. The corresponding characters are thus orientated according to the adjusted orientation angles.

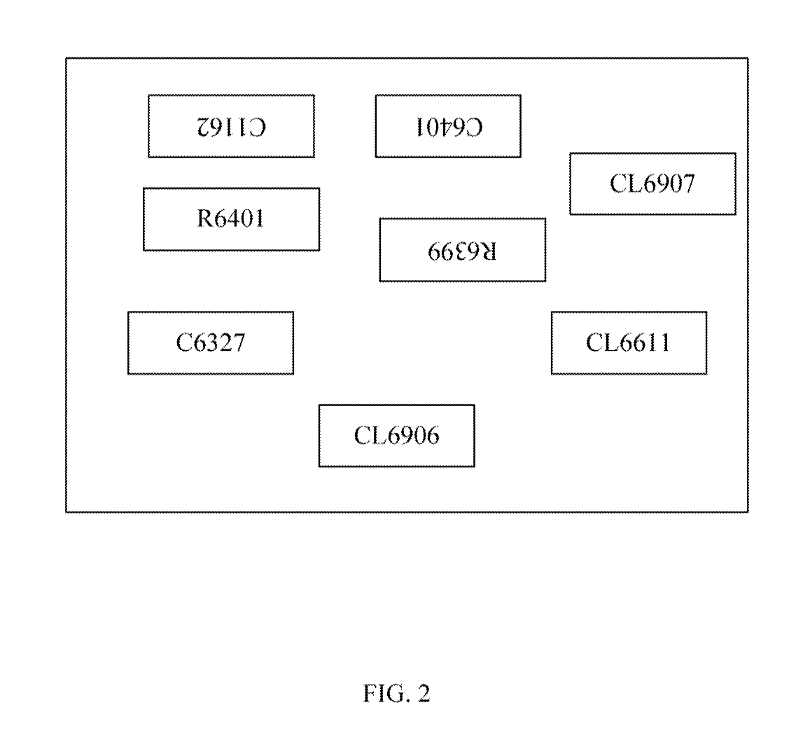

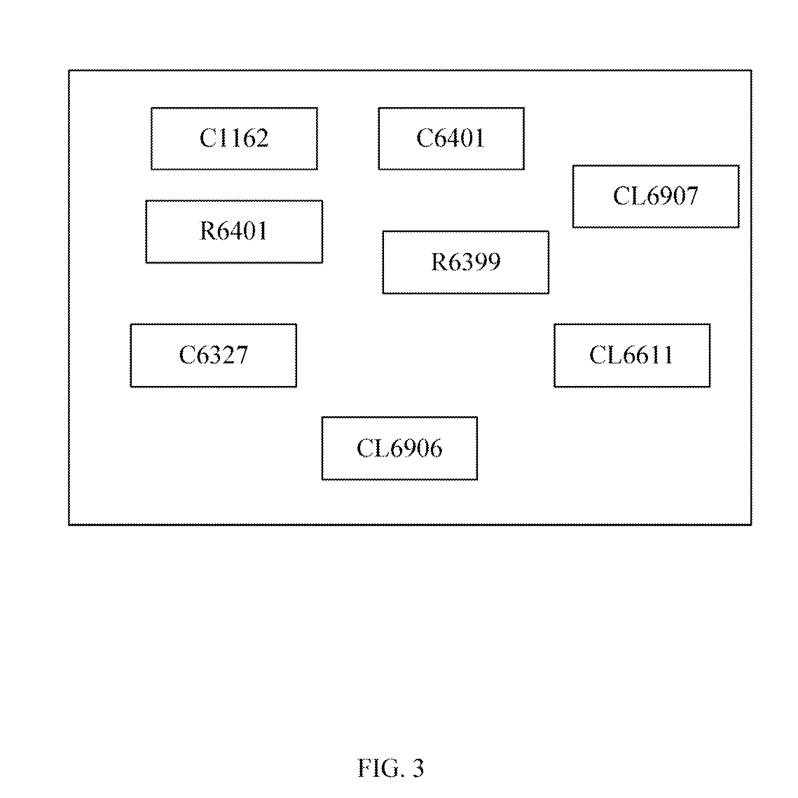

For example, if the predetermined angle of the character is 0 degrees, as shown in FIG. 2, but the characters C1162, C6401, R6399 are oriented at 180 degrees, and the characters R6401, C6327, CL6907, CL6611, CL6906 are oriented at 0 degrees, then the adjusting module 30 adjusts the orientation angles of the characters C1162, C6401, R6399 to 0 degrees. FIG. 3 shows the result of the adjustment.

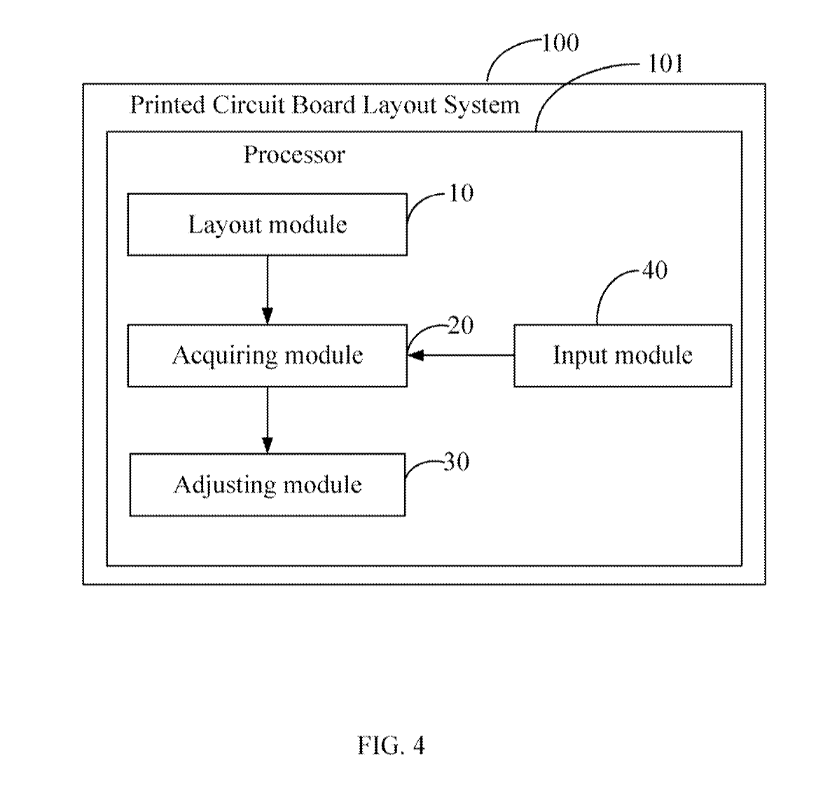

Referring to FIG. 4, in another embodiment, the system 100 further includes an input module 40. The input module 40 is configured for generating a predetermined angle in response to a user input, and providing the predetermined angle to the adjusting module 30. The input module 40 may be a keyboard.

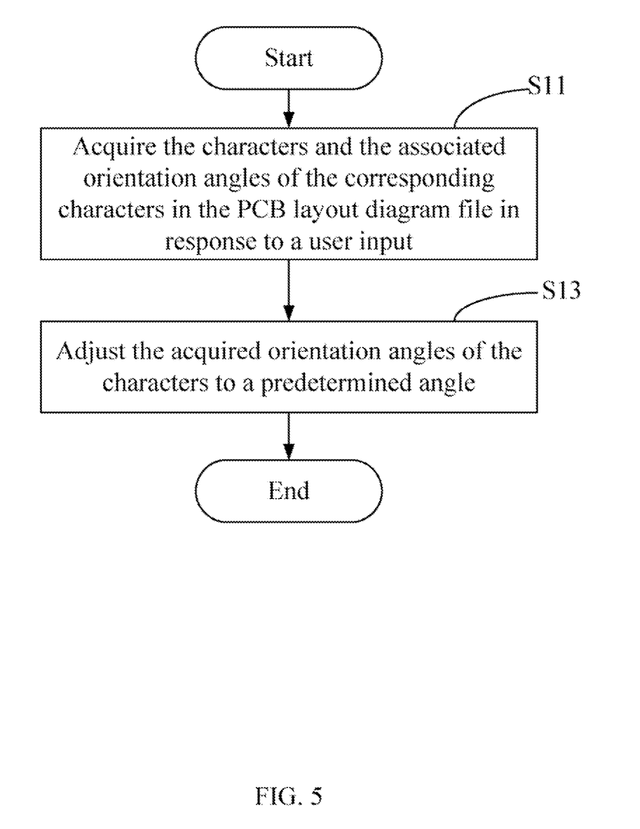

FIG. 5 is a flowchart of a method for adjusting the character orientation implemented by the processor of the system of FIG. 1, in accordance with an exemplary embodiment.

In step S11, the acquiring module 20 acquires the characters and the associated orientation angles of the corresponding characters in the PCB layout diagram file and sends them to the adjusting module 30 in response to a user input.

In step S13, the adjusting module 30 adjusts the orientation angles of the characters to the predetermined angle.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A printed circuit board (PCB) layout system, comprising:
a processor to execute a plurality of function modules, the function modules comprising:
a layout module configured for creating a PCB layout diagram file based on a circuit schematic diagram, wherein the printed circuit board layout diagram file comprises a plurality of characters and orientation angles associated with the characters, the plurality of characters are orientated according to the corresponding orientation angles;
an acquiring module configured for acquiring the characters and the associated orientation angles in response to a user input; and
an adjusting module configured for adjusting the orientation angles of the characters to a predetermined angle.

2. The printed circuit board layout system as described in claim 1, wherein the adjusting module compares the orientation angles of the characters with the predetermined angle, and adjusts the orientation angles of the character to the predetermined angle if the orientation angles of the characters are different from the predetermined angle.

3. The printed circuit board layout system as described in claim 1, further comprising an input module, wherein the input module is configured for generating the predetermined angle in response to a user input, and sending the predetermined angle to the adjusting module.

4. The printed circuit board layout system as described in claim 3, wherein the input module is a keyboard.

5. A method for adjusting the orientation angles of the characters from a printed circuit board layout diagram file created based on a circuit schematic diagram, wherein the printed circuit board layout diagram file comprises a plurality of characters and orientation angles associated with the characters, the plurality of characters are orientated according to the corresponding orientation angles; the method comprising:
acquiring the characters and the associated orientation angles in response to a user input;
adjusting the acquired orientation angles of the characters to a predetermined angle.

6. The method for adjusting the orientation angles of the characters as described in claim 5, wherein the step for adjusting the orientation angles of the characters to the predetermined angle comprises:
comparing the orientation angles of the characters with the predetermined angle; and
adjusting the orientation angles of the characters to the predetermined angle if the orientation angles of the characters are different from the predetermined angle.

7. A (PCB) layout system, comprising:
a processor configured for creating a PCB layout diagram file based on a circuit schematic diagram, wherein the printed circuit board layout diagram file comprises a plurality of characters and orientation angles associated with the characters, the plurality of characters are orientated according to the corresponding orientation angles; configured for acquiring the characters and the associated orientation angles in response to a user input; and adjusting the orientation angles of the characters to a predetermined angle.

8. The PCB layout system as described in claim 7, wherein the processor compares the orientation angles of the characters with the predetermined angle, and adjusts the orientation angles of the character to the predetermined angle if the orientation angles of the characters are different from the predetermined angle.

9. The PCB layout system as described in claim 7, wherein the processor further generates the predetermined angle in response to a user input.
